(19) United States
(12) Patent Application Publication
(10) Pub. No.: US 2009/0177630 A1
(43) Pub. Date: Jul. 9, 2009

(54) Stampez online internet stamp identified

(76) Inventors: Martin Joseph Gore, Nambour (AU); Veronica Bayliss, Nambour (AU); Anthony William Corrigan, Noosaville (AU)

Correspondence Address: Anthony William Corrigan, 17 Ann Street, Noosaville, Queensland, 4566, AU

(21) Appl. No.: 12/317,286

(22) Filed: Dec. 23, 2008

(30) Foreign Application Priority Data
Jan. 3, 2008 (US) US.61/007877

(51) Int. Cl. G06F 17/30

(52) U.S. Cl. 707/3; 707/104.1; 707/E17.044; 707/E17.014; 707/E17.005; 707/200

(57) ABSTRACT

Online Internet application where the user can input any details known about any postage stamp, scan the image of a stamp or stamps that require identification into the online application and identification will be provided by comparing the details to database containing details of all postage stamps or comparing the uploaded scan to images in the Stampez database using specifically designed image comparison technology. The image comparison technology will provide either an exact match or number of matches based on the percentage likelihood of accuracy. The percentage of accuracy can be reduced or broadened by the user. Besides pictorial identification the application will also provide country of origin, date stamp was issued, market price, thematic category, unique identification code, perforations and watermark of postage stamps.

Stampez Online Internet stamp identifier, an online application where the user can input any details known about any postage stamp, scan the image of a stamp or stamps that require identification into the online application and identification will be provided by comparing the details to database containing details of all postage stamps or comparing the uploaded scan to images in the Stampez database using specifically designed image comparison technology. The image comparison technology will provide either an exact match or number of matches based on the percentage likelihood of accuracy. The percentage of accuracy can be reduced or broadened by the user. Besides pictorial identification of the stamp or stamps the application will also provide the user with the country of origin, date stamp was issued market price, thematic category, unique identification code, perforations and watermark of postage stamp or stamps the user is seeking to identify.

### BACKGROUND OF THE INVENTION

1. Field of the Invention

The present invention provides an online internet application that will allow the user to quickly identify any postage stamp providing pictorial confirmation coupled with the country that issued the stamp, the year the stamp was issued, the face value of the stamp upon issue, colour description and details of the stamp, market price, thematic category, unique identification code, perforations and watermark for every possible match to the original scan or scans

2. Description of the Prior Art

The usual method of stamp identification has been by searching through printed catalogues produced by a number of companies or CD Rom which is nothing more than a catalogue on disk. Both these mediums have no search facility, are incomplete as do not provide full list of stamp images, are expensive and do not provide update services.

The companies that produce the catalogues and CD Rom's identify each stamp with a numeral code known in the industry as a catalogue number. That catalogue number also includes an alpha prefix that identifies the company that has produced the catalogues or CD Rom's. Therefore if you are reduced to searching the internet in an effort to find information that might assist in identifying a stamp you end up with numerous possibilities as the stamps will have same number and there is no data in the catalogue number that can assist with identifying the country of stamp issue which is critical information with regards to stamp identification.

The result is that identification of issued postage stamps is a mostly manual, time consuming and costly process that the majority of stamp collectors cannot afford

### SUMMARY OF THE DISCLOSURE

It is the object of the present invention to provide all stamp and philately collectors with an affordable online internet solution that will provide fast identification of any issued postage stamp.

It is another object of the present invention to provide all stamp and philately collectors with online image comparison identification of any issued postage stamp.

It is another object of the present invention to provide stamp and philately collectors with information about a stamp or stamps which is relevant to that stamp. The information provided will include country of issue, date of first issued, face value, colour description, market price, thematic category, unique alpha numerical code based on country and order of issue, perforations and watermark of any issued postage stamps.

It is another object of the present invention to provide stamp and philately collectors with an up to date service where stamps can be identified as issued. This will negate the need to purchase new complete sets of catalogues or CD Rom's each year just to obtain information on stamps issued the previous year.

1. An online internet application that comprises a database that contains all known and complete information required for the identification of any issued postage stamps. The database record for an issued stamp contains a scan or image of that stamp. The data record attached to the scan or image includes the country which issued the stamp, the year the stamp was issued, the face value of the stamp upon issue, colour description and face details of the stamp, market price, thematic category, unique identification code, perforations and watermark of postage stamps.

2. A method of claim 1 where the user can input any data into a search facility provided in the application and no matter how limited that data regarding a postage stamp the application will provide the image of a single or multiple stamps that fit the criteria based on the data input no matter how limited.

3. A method of claim 1 where the user can adjust the percentage parameters of the likelihood of a match upward or downwards in order to produce more or less possible matches to the data input.

4. A method of claim 1 where the user can input any data into a search facility, no matter how limited that data regarding a postage stamp, and the application will provide the image of a single or multiple stamps that fit the criteria based on the data input coupled with the country that issued the stamp, the year the stamp was issued, the face value of the stamp upon issue, colour description and details of the stamp, market price , thematic category, unique identification code, perforations and watermark for each match provided.

5. A method of claim 1 where the user has the option of scanning the image of a stamp or stamps using any appropriate scanner. Then by selecting a scan upload option in the application the stamp or stamps images will be transferred into the online stamp identification application. The stamp or stamps will be identified by the use of specially designed image comparison computer software which will compare the stamp(s) to a complete database of postage stamps and then within seconds provide the user with a an exact match or number of possible matches based the probability of that match coupled with the country that issued the stamp, the year the stamp was issued, the face value of the stamp upon issue, colour description and details of the stamp, market price, thematic category, unique identification code, perforations and watermark for every possible match to the original scan or scans

6. A method of claim 1 where the user can adjust the percentage parameters of the likelihood of a match upward or downwards in order to produce more or less possible matches to the image/scan of any stamp or stamps.

7. A method of claim 1 where the user has the option of scanning the image of a stamp or stamps using any appropriate scanner as well as inputting any known data or information regarding that stamp into the application search facility. Then by selecting an upload option in the application the stamp or stamps images and data will be transferred into the online stamp identification application. The stamp or stamps will be identified by the use of specially designed image comparison computer software which will compare the stamp(s) and provided data to a complete database of postage stamps and then within seconds provide the user with a an exact match or number of possible matches based the probability of that match coupled with the country that issued the stamp, the year the stamp was issued, the face value of the stamp upon issue, colour description and details of the stamp, market price , thematic category, unique identification code, perforations and watermark for every possible match to the original scan or scans

8. A method of claim 1 where the user can adjust the percentage parameters of the likelihood of a match upward or downwards in order to produce more or less possible matches to the data input. This adjustment applies to both scanned images and any data the user has selected to input that will assist in identifying a stamp or stamps.

9. A method of claim 1 where the user will have access to the latest issued stamps due to regular and continued updating of the database.
